(19) United States
(12) Patent Application Publication
(10) Pub. No.: US 2017/0134714 A1
(43) Pub. Date: May 11, 2017

(54) DEVICE AND METHOD FOR CREATING VIDEOCLIPS FROM OMNIDIRECTIONAL VIDEO

(71) Applicant: Microsoft Technology Licensing, LLC, Redmond, WA (US)

(72) Inventors: Shahil Soni, Bellevue, WA (US); Esa Kankaanpää, Hyvinkaa (FI); Klaus Melakari, Oulu (FI)

(21) Appl. No.: 14/938,606

(22) Filed: Nov. 11, 2015

(51) Int. Cl. H04N 13/02; H04N 13/00; G11B 27/34; G11B 27/034; H04N 5/265; H04N 5/232; H04N 5/77

(52) U.S. Cl. CPC H04N 13/0282; H04N 5/23238; H04N 13/0055; H04N 13/0014; H04N 5/772; G11B 27/034; H04N 5/265; G11B 27/34; H04N 13/0296; H04N 13/0066; H04N 2013/0092

(57) ABSTRACT

A device for creating video clips from an omnidirectional video is presented. The device comprises at least one processor and a memory including computer program code. The memory is configured to store an omnidirectional video comprising a series of image frames, and the code is configured to cause the device to: identify two or more regions of interest in a segment comprising a sequence of image frames of the omnidirectional video, the regions identified based at least partly on one or more active objects detected in the segment, define two or more digital viewpoints, wherein each digital viewpoint encloses at least one region of interest throughout the segment, create a set of video clips, wherein each video clip is composed of a sequence of images formed by a single digital viewpoint throughout the segment, and assign a common timeline to each of the video clips.

### BACKGROUND

Omnidirectional cameras which cover a wide angle image, such as 180 or 360-degrees in the horizontal pane, or both in horizontal and vertical panes, have been used in panoramic imaging and video recording. The images and videos recorded by such cameras can be played back by consumer electronic devices, and normally the device user is given control over which segment of the 360 frame is displayed. Multiple viewpoints of a wide angle video may be presented on the same screen. This can be done for example by manually choosing the viewpoints during playback.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

A device, system and method are presented. The device and method comprise features which allow creating video clips from omnidirectional video footage based on two or more regions of interest. These video clips can also be used to create a new video from their combination according to predetermined rules. The system also comprises a 360-camera and is adapted to perform the same actions in real-time as the footage is being recorded.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic illustration of the main components of a device according to an embodiment;

FIG. 2 is a schematic illustration of a system according to an embodiment;

FIG. 3a is a graphic illustration of an embodiment;

FIG. 3b is a schematic timeline for embodiment shown in FIG. 3a;

FIG. 4a is a graphic illustration of a first digital viewpoint according to an embodiment;

FIG. 4b is a graphic illustration of a second digital viewpoint according to the embodiment;

FIG. 4c shows movement of the first viewpoint shown in FIG. 4a;

FIG. 4d is a schematic timeline for the embodiment shown in FIGS. 4a-4c; and

FIG. 5 is a schematic illustration of a system according to an embodiment.

Like reference numbers correspond to like elements on the drawings.

### DETAILED DESCRIPTION

The detailed description provided below in connection with the appended drawings is intended as a description of the embodiments and is not intended to represent the only forms in which the embodiments may be constructed or utilized. The description sets forth the structural basis, functions and the sequence of operation steps. However, the same or equivalent functions and sequences may be accomplished by different embodiments not listed below.

Although some of the present embodiments may be described and illustrated herein as being implemented in a personal computer or a portable device, these are only examples of a device and not a limitation. As those skilled in the art will appreciate, the present embodiments are suitable for application in a variety of different types of devices incorporating a processor and a memory. Also, despite some of the present embodiments being described and illustrated herein as being implemented using omnidirectional video footage and cameras, these are only examples and not a limitation. As those skilled in the art will appreciate, the present embodiments are suitable for application in a variety of different video formats in which the image has a wider field of view than what is displayed on a display device. The omnidirectional field of view may be partially blocked by a camera body. The omnidirectional camera can have a field of view over 180 degrees. The camera may have different form factors; for example, it may be a flat device with a large display, a spherical element or a baton comprising a camera element.

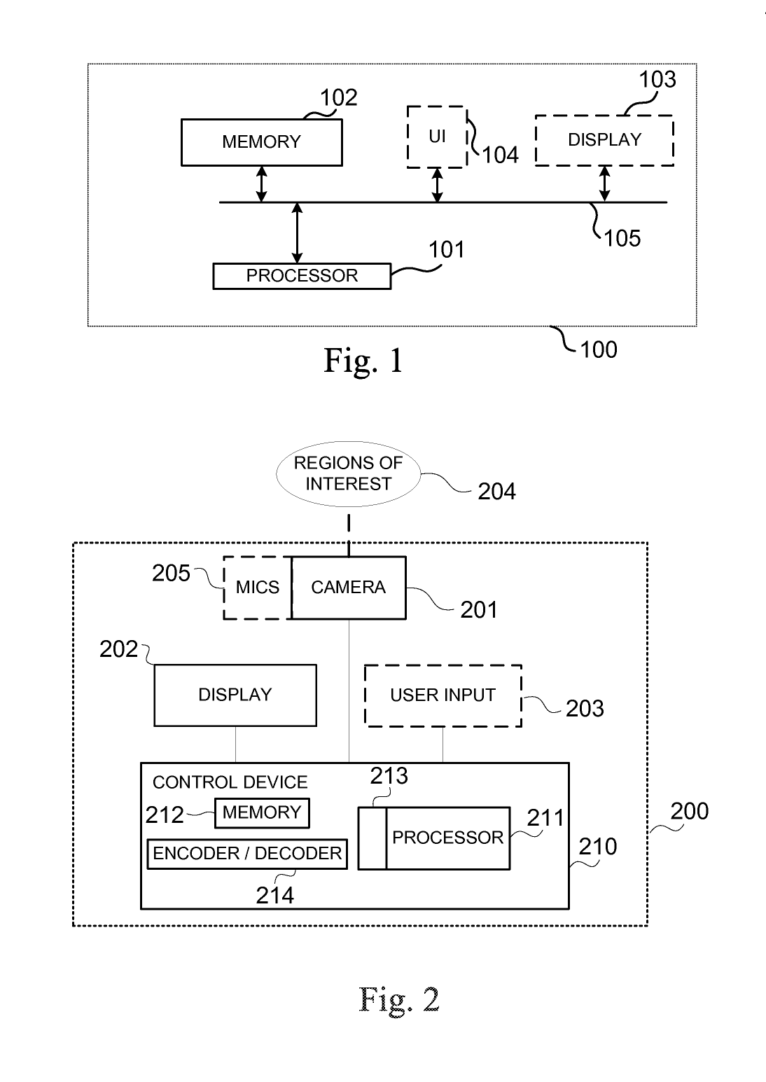

FIG. 1 shows a basic block diagram of an embodiment of the device 100. The device 100 may be any device adapted to modify omnidirectional videos. For instance, the device 100 may be a device for editing omnidirectional videos, a personal computer, or a handheld electronic device. For the purposes of this specification, “omnidirectional” means that the captured image frames have a field of view wider than what is displayed on a display 103, so that a viewpoint needs to be selected within these image frames in order to display the video.

The device 100 comprises at least one processor 101 and at least one memory 102 including computer program code, and an optional display element 103 coupled to the processor 101. The memory 102 is capable of storing machine executable instructions. The memory 102 may also store other instructions and data, and is configured to store an omnidirectional video. Further, the processor 101 is capable of executing the stored machine executable instructions. The processor 101 may be embodied in a number of different ways. In an embodiment, the processor 101 may be embodied as one or more of various processing devices, such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In at least one embodiment, the processor 101 utilizes computer program code to cause the device 100 to perform one or more actions.

The memory 102 may be embodied as one or more volatile memory devices, one or more non-volatile memory devices or a combination thereof For example, the memory 102 may be embodied as magnetic storage devices (such as hard disk drives, floppy disks, magnetic tapes, etc.), optical magnetic storage devices (e.g. magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.). In an embodiment, the memory 102 may be implemented as a remote element, for example as cloud storage.

The computer program code and the at least one memory 102 are configured, with the at least one processor 101, to cause the device to perform a sequence of actions listed below.

Two or more regions of interest are first identified in a segment comprising a sequence of image frames of the omnidirectional video, wherein the two or more regions of interest identified based at least in part on one or more active objects detected in the segment. The term ‘segment’ as used herein refers to a collection of successive image frames in the omnidirectional video. In some embodiments, wherein a longer part of the video is to be processed, a segment can be chosen by the processor 101 to include a large number of successive image frames; whereas in some embodiments, where the series of image frames includes a small number of image frames, a segment can be chosen by the processor 101 to include only a few successive image frames (for example, image frames related to a particular action or a movement captured in the omnidirectional video).

In an embodiment, the processor 101 is configured to detect one or more active objects in a segment. The term ‘active object’ as used herein refers to an object associated with movement, sound any other visibly active behavior. In an illustrative example, if two individuals are engaged in a conversation (i.e. associated with sound, being captured by a directional microphone), then each individual may be identified as an active object by the processor 101. Similarly, if the segment includes a moving vehicle, then the vehicle may be identified as an active object, associated potentially with movement, action and sound. In yet another illustrative example, if the segment captures a scene of an animal running away from a predator, then both the animal and its predator may be detected as active objects by the processor 101. In an embodiment, the processor 101 may utilize any of face detection, gaze detection, sound detection, motion detection, thermal detection, whiteboard detection and background scene detection to detect the one or more active objects in the segment.

In an embodiment, the processor 101 is configured to identify two or more regions of interest in the segment based at least in part on the one or more active objects in the segment. The term ‘region of interest’ as used herein may refer to a specific portion of the segment or the video that may be of interest to a viewer of the omnidirectional video. For example, if the segment includes three people involved in a discussion, then a viewer may be interested in viewing the person who is talking as opposed to a person who is presently not involved in the conversation. In some embodiments, the processor 101 is configured to identify the regions of interest based on detected active objects in the segment. However, in some embodiments, the processor 101 may be configured to identify regions of interest in addition to those identified based on the active objects in the scene. For example, the processor 101 may employ whiteboard detection to identify presence of a whiteboard in the scene. If a person (an active object) is writing on the whiteboard, then the viewer may be interested in seeing what is written on the whiteboard in addition to what the person is saying while writing on the whiteboard. Accordingly, the processor 101 may identify a region of interest including both the whiteboard and the person writing on the whiteboard.

Two or more digital viewpoints, wherein each digital viewpoint encloses at least one region of interest in at least one image frame of the segment, are also defined by the processor 101. The processor 101 then adjusts the two or more digital viewpoints so that the at least one region of interest remains in the displayed portion throughout the segment. A digital viewpoint referred to herein is a segment of the captured omnidirectional image that is displayed to a user. Each region of interest may have a digital viewpoint assigned to it, and throughout the segment, or in all image frames of the segment, the digital viewpoint remains “locked” on its at least one region of interest.

After two or more digital viewpoints are defined and adjusted, the processor 103 can create a set of video clips from what each of the digital viewpoints provide, so the video clips are composed of a sequence of images formed by a single digital viewpoint throughout the segment. This can be compared to multiple camera angles, except the omnidirectional image frames in which multiple digital viewpoints can be chosen originate from only one omnidirectional camera.

Finally, the processor 101 assigns a common timeline to each of the created video clips, so that each video clip can easily be accessed at a certain point in time within the segment.

In an embodiment, the resulting video clips with the assigned timelines (for example as metadata) can also be stored in the memory 102. As mentioned above, the memory 102 is not limited to hardware physically connected to the device 100 or processor 101, and may be for example a remote cloud storage accessed via the Internet.

The embodiments above have a technical effect of gathering relevant and/or eventful parts of an omnidirectional video, and providing these parts in separate videos with a common timeline which facilitates easy editing afterwards.

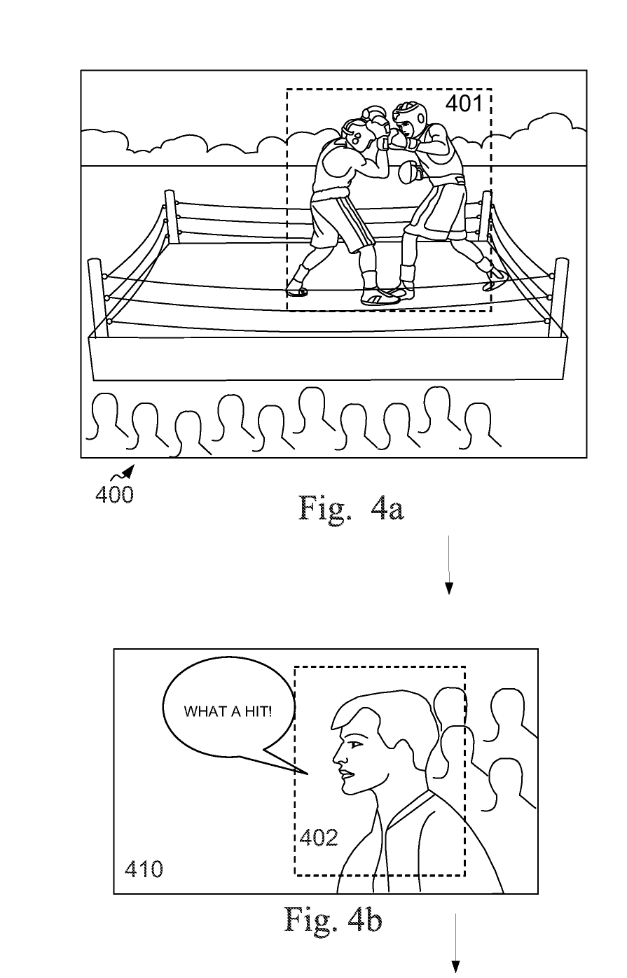

According to an embodiment, the memory 102 is configured, with the at least one processor 101, to cause the device 100 to combine two or more video clips from the set of created video clips according to a predetermined pattern or ruleset based on the assigned common timeline, and create a new video from the combined video clips. In the embodiment, the new created video can also be stored in the memory 102. Depending on the predetermined pattern or ruleset, different videos may be “compiled” from the video clips. A few exemplary patterns are described below with reference to FIGS. 3a-3b.

In an embodiment, the device 100 comprises a user interface element 104 coupled to the processor 101 and a display 103 coupled to the processor. The processor 101 is configured to provide, via the user interface element 104 and the display 103, manual control to a user over certain functions, for example identifying two or more regions of interest, defining two or more digital viewpoints, or combining two or more video clips from the set of video clips based on the assigned common timeline. The functionality may partially be made manual if a user wishes to specifically focus on certain regions of interest, for example. The new video created e.g. from synchronized video clips can be displayed on the display element 103, as well as any of the video clips separately. Examples of the display element 103 may include, but are not limited to, a light emitting diode display screen, a thin-film transistor (TFT) display screen, a liquid crystal display screen, an active-matrix organic light-emitting diode (AMOLED) display screen and the like. Parameters of the digital viewpoints in the image frames which are displayed can depend on the screen type, resolution and other parameters of the display element 103. The user interface (UI) element may comprise UI software, as well as a user input device such as a touch screen, mouse and keyboard and the like.

In an embodiment, the video stored in the memory 102 is prerecorded, and the functionality listed above is done in post-production of an omnidirectional video.

In an embodiment, various components of the device 100, such as the processor 101, the memory 102, the display 103 and the user interface 104 may communicate with each other via a centralized circuit system 105. Other elements and components of the device 100 may also be connected through this system 105. The centralized circuit system 105 may be various devices configured to, among other things, provide or enable communication between the components of the device 100. In some embodiments, the centralized circuit system 105 may be a central printed circuit board (PCB) such as a motherboard, a main board, a system board, or a logic board. The centralized circuit system 105 may also, or alternatively, include other printed circuit assemblies (PCAs) or communication channel media.

The device 100 may include more components than those depicted in FIG. 1. In an embodiment, one or more components of the apparatus 100 may be implemented as a set of software layers on top of existing hardware systems. In an exemplary scenario, the apparatus 100 may be any machine capable of executing a set of instructions (sequential and/or otherwise) so as to create a set of video clips from omnidirectional camera footage.

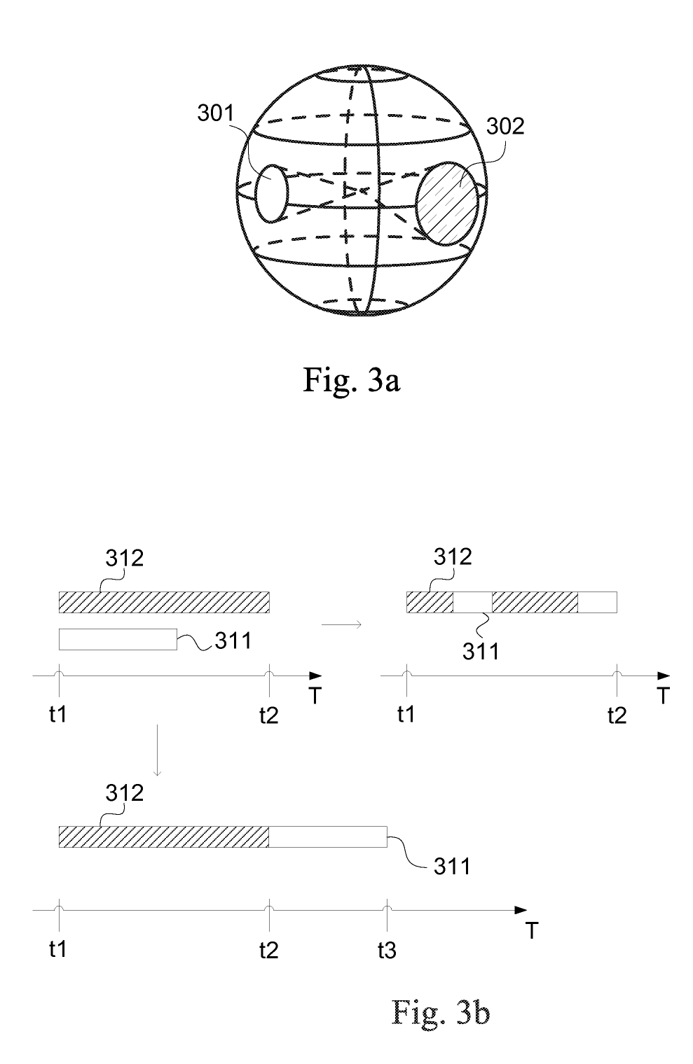

FIG. 2 illustrates a system 200 according to an embodiment. The system 200 comprises a device 210 comprising at least one processor 211 and at least one memory 212 including computer program code, a display unit 202 coupled to the device 210, and a camera 201 coupled to the device 210 and configured to capture an omnidirectional video comprising a series of image frames.

The camera 201 according to the embodiment may be associated with an image-capture field of view of at least degrees in at least one of a horizontal direction and a vertical direction. For example, the camera 201 may be a ‘360 camera’ associated with a 360×360 spherical image-capture field of view. Alternatively, the camera 201 may be associated with an image-capture field of view of 180 degrees or less than 180 degrees, in which case, the system 200 may comprise more than one camera 201 in operative communication with one another, such that a combined image-capture field of view of the one or more cameras is at least 180 degrees. The camera 201 may include hardware and/or software necessary for capturing a series of image frames to generate a video stream. For example, the camera 201 may include hardware, such as a lens and/or other optical component(s) such as one or more image sensors. Examples of an image sensor may include, but are not limited to, a complementary metal-oxide semiconductor (CMOS) image sensor, a charge-coupled device (CCD) image sensor, a backside illumination sensor (BSI) and the like. Alternatively, the camera 201 may include only the hardware for capturing video, while a memory device of the device 210 stores instructions for execution by the processor 211 in the form of software for generating a video stream from the captured video. In an example embodiment, the control device 210 may further include a processing element such as a co-processor 213 that assists the processor 211 in processing image frame data and an encoder and/or decoder 214 for compressing and/or decompressing image frame data. The encoder and/or decoder may encode and/or decode according to a standard format, for example, a Joint Photographic Experts Group (JPEG) standard format. The camera 201 may also be an ultra-wide angle camera.

The computer program code and the at least one memory are configured, with the at least one processor, to cause the device to perform actions similar to the devices described above. These actions include storing an omnidirectional video, in this case the video that is captured by the camera 201, identifying two or more regions of interest 204 in a segment of the video, defining two or more digital viewpoints, at least one per region of interest 204 and enclosing the said region of interest in at least one frame, and adjusting the two or more digital viewpoints so that the at least one region of interest 204 remains in the displayed portion throughout the segment, creating a set of video clips showing the segment through each digital viewpoint, assigning a common timeline to the video clips and recording metadata in the memory 212, wherein the metadata comprises the common timeline assigned to each of the clips.

The system 200 may be used, similarly to the device 100, in post-production of the already captured omnidirectional video, wherein in the system 200 this video would be captured by the omnidirectional camera 201 and stored in the memory 212. In some embodiments of the system 200, some of the listed actions can be performed in real time (or with a delay) while the camera 201 is capturing the omnidirectional video. In an embodiment, the processing unit 211 may be configured to identify, or receive a command with an identification of, two or more regions of interest 204, define two or more digital viewpoint and record separate videos formed by sequences of images formed by each digital viewpoint, all while the video is being captured by the camera 201.

In an embodiment, the system comprises a directional audio recording unit 205 coupled to the processing unit 211, and the processing unit 211 is configured to record an audio stream along with the captured omnidirectional video into the memory 212, and focus the directional audio recording on at least one of the regents of interest 204. In an embodiment, the directional audio recording unit 205 comprises two or more directional microphones. This allows switching more easily between the directions, and focusing the audio recording on more than one region of interest 204 at the same time. The system can also comprise an omnidirectional or any other audio recording unit coupled to the processing unit 211. The audio recording unit may comprise a conventional microphone to record sound of the whole scene.

In an embodiment, the system 200 also comprises a user input unit 203 which may be part of the same element as the display 202, or stand apart as an autonomous unit. The user interface 203 allows users to switch some of the functionality to a manual mode, for example to provide help in identifying a region of interest. According to an embodiment, the system 200 comprises a gaze detection element, and the device 210 can then record metadata regarding gaze direction of a camera user. This can have an application when identifying a region of interest 204, since the gaze direction of a camera user may be interpreted as user input information.

In all of the above embodiments, metadata recorded to the memory 212 is not limited to common timelines or gaze detection information, and may include any other information that is gathered and relevant to the created video clips.

FIG. 3a is a schematic illustration of a horizontally and vertically 360 camera field of view, substantially covering the whole sphere around the camera. In this exemplary embodiment, two regions of interest are identified, and so digital viewpoints 301 and 302 which enclose both regions of interest are created. A video comprising one or more segments is recorded. As the recorded segment progresses, the digital viewpoints' positions may change as the active objects in regions of interest are moved, or as the camera itself moves. When the recording of a segment is finished in the recorded video, two video clips can be created—311 and 312, and a timeline T indicating a starting time of the segment t1 and an end time of the segment t2 is assigned to each of the recorded clips 311, 312. As can be seen in the example of FIG. 3b, the first video clip 311 is shorter than the second, for example due to the fact that the region of interest in the viewpoint 301 has been active for a shorter period of time and not throughout the whole segment. According to an embodiment, the recorded video clips 311, 312 (and as it is obvious to a skilled person, there may be more than two clips even if there are only two regions of interest, for example one of them may be based on a digital viewpoint that enclose both regions) are combined according to a predetermined pattern based on the assigned common timeline T. In an embodiment, the predetermined pattern comprises an order of video clips 311, 312 wherein different video clips for the same segment of the common timeline are combined one after another uninterrupted. This embodiment is illustrated on the lower part of FIG. 3b. The resulting new video created according to this pattern is a continuous video which is longer than both the original clips and simply plays through the same moments from different point of views, consequently. In another embodiment, the pattern comprises a synchronized sequence, or synchronization instructions, based on the assigned common timeline. The device 210 then is configured to determine a priority of parts of each video clip of the set of video clips based on at least one predetermined parameter, and provide the parts of video clips for synchronization based on the determined priority. The predetermined parameter may be, for example, the presence/absence of activity or an active object in at least one region of interest enclosed by a particular digital viewpoint at any given time. In this case, the more activity there is in a region of interest at a certain point in time, the more priority this part of the video clip receives around that moment. The processor may be configured to create a diagram of priority of each video clip against time and provide the user with visual feedback on the priories at any given moment. In an embodiment, the device is configured to have a timer according to which the next “cut” in the video may not occur for a predetermined number of seconds, to avoid an unpleasant viewing experience. This helps automate the “editing” of a video that is combined from the video clips 311, 312. The top right part of FIG. 3b illustrates the synchronization based on a predetermined parameter, and because the videos are synchronized, the events do not repeat but rather the video is “cut” from one clip to another, as the segment progresses from t1 to t2.

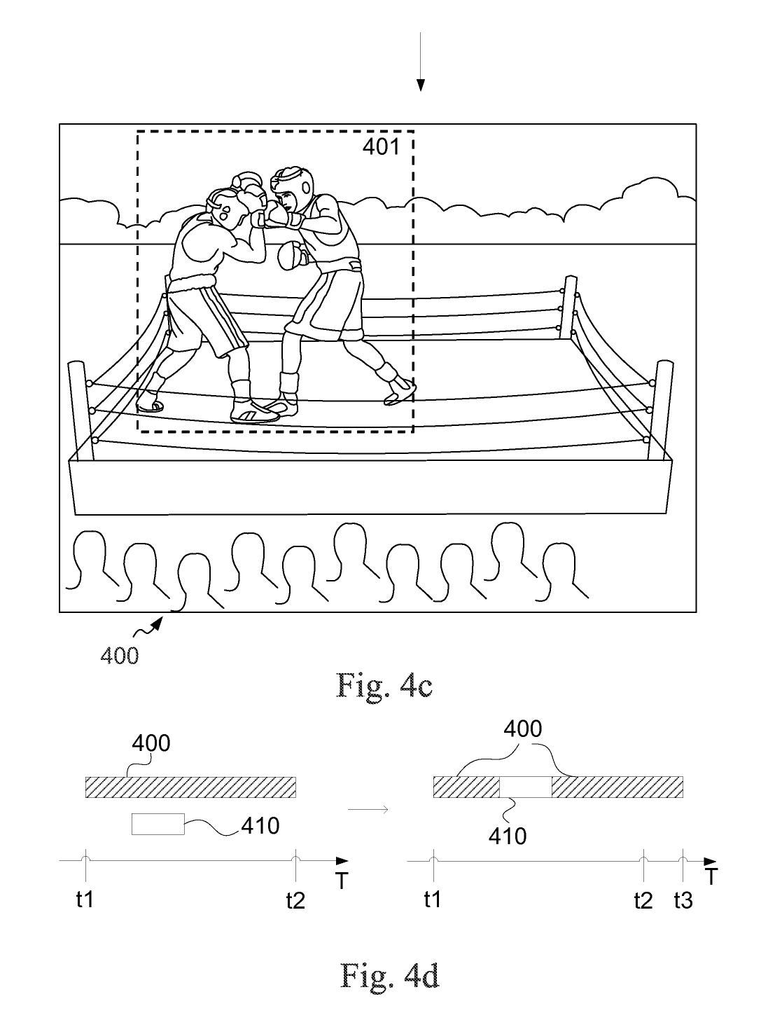

FIGS. 4a-4c illustrate another exemplary embodiment. In this embodiment, a boxing match is shown in a first digital viewpoint 400 enclosing the first region of interest 401, naturally the fighters. In the embodiment, the device is configured to recognize a friend's voice and/or appearance in the omnidirectional video, and identify him or her as a second region of interest 402. When the friend shouts out something during the match, for example “what a hit!”, priority of the video clip of digital viewpoint 410 becomes higher than the priority of the clip showing the match for a short period of time. Then the video returns to the match view 400. This may also be done in post-production, and according to the pattern wherein the same segment is shown repeatedly from all viewpoints, i.e. the video clips are stacked together. In the embodiment shown on FIGS. 4a-4c, this would allow to see a friend's reaction in 410, and then watch the same time segment (presumably a hit) again in the match itself through 400, or in any other order. FIG. 4d shows a possible timeline of the events shown in FIGS. 4a-4c, wherein 400 corresponds to the video of the boxing match created through the digital viewpoint 400, and 410 corresponds to the video of a friend. As shown, the whole segment lasts from t1 to t2, and the resulting video is longer (from t1 to t3) since the pattern used for this scenario is to insert the clip 410 just before a moment occurs, and then repeat the moment from the original point of view 400. This pattern wherein a video clip is inserted into another video clip, extending the resulting video, is provided as an example only.

A technical effect of the above embodiments is that multiple digital viewpoints of a single omnidirectional camera can be used as “separate cameras”, and editing of the created video clips can either be automatic, according to predetermined parameters, or simplified manual editing. The embodiments can be used for capturing all aspects of complex and sometimes fast paced events, for example in sports, talk shows, lectures, seminars etc.

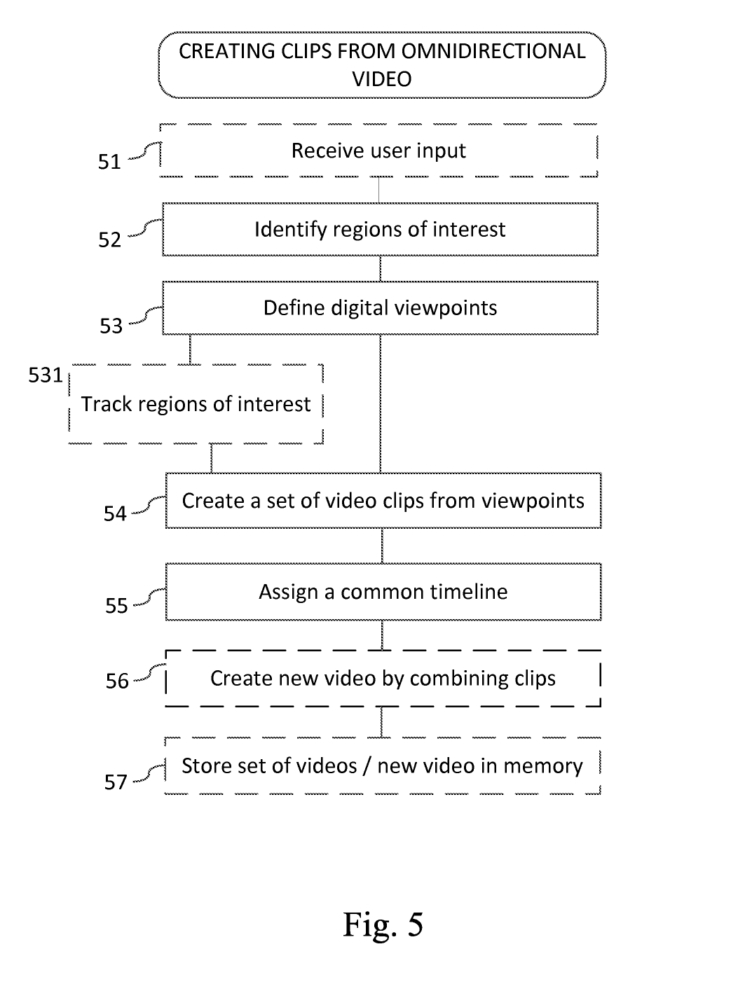

FIG. 5 shows a method according to an embodiment. The method comprises identifying 52 two or more regions of interest in a segment comprising a sequence of image frames of the omnidirectional video. The two or more regions of interest are identified based at least in part on one or more active objects detected in the segment, or they may be identified at least in part based on a user input 51 comprising a selection of two or more regions of interest. The method further comprises defining 53 two or more digital viewpoints, wherein each digital viewpoint encloses at least one region of interest throughout the segment, creating 54 a set of video clips. Each video clip of the set is composed of a sequence of images formed by a single digital viewpoint throughout the segment. A common timeline is then assigned 55 to each of the video clips in the set of video clips.

In an embodiment, the method further comprises creating 56 a new video by combining two or more video clips from the set of video clips according to a predetermined pattern based on the assigned common timeline. Alternatively, the method can comprise receiving user input comprising instructions to combine the video clips, combining the video clips based on these instructions and creating a new video from this combination. The new video can also be stored 57 in the memory.

According to an embodiment, each digital viewpoint encloses at least one region of interest throughout the segment by locking onto and tracking 531 the at least one region of interest.

The methods according to the embodiments above may be performed, for example, by a processor. The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

According to an aspect, a device is provided. The device comprises at least one processor and a memory including computer program code. The memory is configured to store an omnidirectional video comprising a series of image frames, and the computer program code and the at least one memory are configured, with the at least one processor, to cause the device to: identify two or more regions of interest in a segment comprising a sequence of image frames of the omnidirectional video, the two or more regions of interest identified based at least in part on one or more active objects detected in the segment, define two or more digital viewpoints, wherein each digital viewpoint encloses at least one region of interest in at least one image frame of the segment, adjust the two or more digital viewpoints so that the at least one region of interest remains in the displayed portion throughout the segment, create a set of video clips, wherein each video clip is composed of a sequence of images formed by a single digital viewpoint throughout the segment, and assign a common timeline to each of the video clips in the set of video clips.

In an embodiment, the computer program code and the at least one memory are configured, with the at least one processor, to cause the device to store the set of video clips with the assigned common timeline in the memory.

In an embodiment, alternatively or in addition to the above embodiments, the computer program code and the at least one memory are configured, with the at least one processor, to cause the device to combine two or more video clips from the set of video clips according to a predetermined pattern based on the assigned common timeline, and create a new video from the combined video clips.

In an embodiment, in addition to the above embodiment, the predetermined pattern comprises an order of video clips wherein different video clips for the same segment of the common timeline are combined one after another uninterrupted.

In an embodiment, alternatively to the above embodiment, the predetermined pattern comprises a synchronized sequence of parts of video clips, wherein the synchronization is based on the assigned common timeline, and the computer program code and the at least one memory are configured, with the at least one processor, to cause the device to determine a priority of parts of each video clip of the set of video clips based on at least one predetermined parameter, and provide the parts of video clips for synchronization based on the determined priority.

In an embodiment, alternatively to the above embodiments, the device comprises a user interface element coupled to the processor and a display coupled to the processor, wherein the computer program code and the at least one memory are configured, with the at least one processor, to cause the device to provide, via the user interface element and the display, manual control over identifying two or more regions of interest, defining two or more digital viewpoints, or combining two or more video clips from the set of video clips based on the assigned common timeline.

In an embodiment, in addition to the above embodiments, the computer program code and the at least one memory are configured, with the at least one processor, to cause the device to store the created new video in a memory.

In an embodiment, alternatively or in addition to the above embodiments, the omnidirectional video is prerecorded.

According to an aspect, a system is provided. The system, comprises: a device comprising at least one processor and at least one memory including computer program code, a display unit coupled to the device, and a camera coupled to the device and configured to capture an omnidirectional video comprising a series of image frames, the camera having an image-capture field of view of at least 180 degrees in at least one of a horizontal direction and a vertical direction. The computer program code and the at least one memory are configured, with the at least one processor, to cause the device to store the omnidirectional video captured by the camera in the memory, identify two or more regions of interest in a segment comprising a sequence of image frames of the omnidirectional video, the two or more regions of interest identified based at least in part on one or more active objects detected in the segment, define two or more digital viewpoints, wherein each digital viewpoint encloses at least one region of interest in at least one image frame of the segment, adjust the two or more digital viewpoints so that the at least one region of interest remains in the displayed portion throughout the segment, create a set of video clips, wherein each video clip is composed of a sequence of images formed by a single digital viewpoint throughout the segment, assign a common timeline to each of the video clips in the set of video clips, and record metadata in the memory, the metadata comprising the common timeline assigned to each of the video clips.

In an embodiment, the system comprises a directional audio recording unit, wherein the computer program code and the at least one memory are configured, with the at least one processor, to cause the device to record an audio stream along with the captured omnidirectional video, and focus the directional audio recording unit on at least one region of interest.

In an embodiment, in addition to the above embodiment, the directional audio recording unit comprises two or more directional microphones.

In an embodiment, alternatively or in addition to the above embodiments, the system comprises a gaze detection unit configured to detect a gaze direction of a camera user, wherein the computer program code and the at least one memory are configured, with the at least one processor, to cause the device to record metadata in the memory, the metadata comprising a detected gaze direction of the camera user.

According to an aspect, a method is provided. The method comprises: identifying two or more regions of interest in a segment comprising a sequence of image frames of the omnidirectional video, the two or more regions of interest identified based at least in part on one or more active objects detected in the segment, defining two or more digital viewpoints, wherein each digital viewpoint encloses at least one region of interest throughout the segment, creating a set of video clips, wherein each video clip is composed of a sequence of images formed by a single digital viewpoint throughout the segment, and assigning a common timeline to each of the video clips in the set of video clips.

In an embodiment, identifying two or more regions of interest comprises receiving user input comprising a selection of two or more regions of interest.

In an embodiment, alternatively or in addition to the above embodiments, the method comprises storing the set of video clips with the assigned common timeline in the memory.

In an embodiment, alternatively or in addition to the above embodiments, the method comprises combining two or more video clips from the set of video clips according to a predetermined pattern based on the assigned common timeline, and creating a new video from the combined video clips.

In an embodiment, in addition to the above embodiments, the method comprises storing the created new video in a memory.

In an embodiment, alternatively or in addition to the above embodiments, each digital viewpoint encloses at least one region of interest throughout the segment by locking onto and tracking the at least one region of interest.

In an embodiment, alternatively or in addition to the above embodiments, the method comprises receiving a user input comprising an instruction to combine two or more video clips from the set of video clips, and combining two or more video clips from the set of video clips according to the user input, and creating a new video from the combined video clips.

In an embodiment, alternatively or in addition to the above embodiments, the method comprises adjusting parameters of the digital viewpoint based on parameters of the identified regions of interest.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the technical effects described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term ‘comprising’ is used herein to mean including the method blocks or elements identified, but that such blocks or elements do not comprise an exclusive list and a method or device may contain additional blocks or elements.

It will be understood that the above description is given by way of example only and that various modifications may be made by those skilled in the art. The above specification, embodiments and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A device comprising:
at least one processor and a memory including computer program code, wherein the memory is configured to store an omnidirectional video comprising a series of image frames, and the computer program code and the at least one memory are configured, with the at least one processor, to cause the device to:
identify two or more regions of interest in a segment comprising a sequence of image frames of the omnidirectional video, the two or more regions of interest identified based at least in part on one or more active objects detected in the segment,
define two or more digital viewpoints, wherein each digital viewpoint encloses at least one region of interest in at least one image frame of the segment,
adjust the two or more digital viewpoints so that the at least one region of interest remains in the displayed portion throughout the segment,
create a set of video clips, wherein each video clip is composed of a sequence of images formed by a single digital viewpoint throughout the segment, and
assign a common timeline to each of the video clips in the set of video clips.

2. A device as claimed in claim 1, wherein the computer program code and the at least one memory are configured, with the at least one processor, to cause the device to store the set of video clips with the assigned common timeline in the memory.

3. A device as claimed in claim 1, wherein the computer program code and the at least one memory are configured, with the at least one processor, to cause the device to
combine two or more video clips from the set of video clips according to a predetermined pattern based on the assigned common timeline, and
create a new video from the combined video clips.

4. A device as claimed in claim 3, wherein the predetermined pattern comprises an order of video clips wherein different video clips for the same segment of the common timeline are combined one after another uninterrupted.

5. A device as claimed in claim 3, wherein the predetermined pattern comprises a synchronized sequence of parts of video clips, wherein the synchronization is based on the assigned common timeline, and the computer program code and the at least one memory are configured, with the at least one processor, to cause the device to
determine a priority of parts of each video clip of the set of video clips based on at least one predetermined parameter, and
provide the parts of video clips for synchronization based on the determined priority.

6. A device as claimed in claim 3, comprising a user interface element coupled to the processor and a display coupled to the processor, wherein the computer program code and the at least one memory are configured, with the at least one processor, to cause the device to provide, via the user interface element and the display, manual control over identifying two or more regions of interest, defining two or more digital viewpoints, or combining two or more video clips from the set of video clips based on the assigned common timeline.

7. A device as claimed in claim 3, wherein the computer program code and the at least one memory are configured, with the at least one processor, to cause the device to store the created new video in a memory.

8. A device as claimed in claim 1, wherein the omnidirectional video is prerecorded.

9. A system, comprising
a device comprising at least one processor and at least one memory including computer program code,
a display unit coupled to the device, and
a camera coupled to the device and configured to capture an omnidirectional video comprising a series of image frames, the camera having an image-capture field of view of at least 180 degrees in at least one of a horizontal direction and a vertical direction; wherein
the computer program code and the at least one memory are configured, with the at least one processor, to cause the device to
store the omnidirectional video captured by the camera in the memory,
identify two or more regions of interest in a segment comprising a sequence of image frames of the omnidirectional video, the two or more regions of interest identified based at least in part on one or more active objects detected in the segment,
define two or more digital viewpoints, wherein each digital viewpoint encloses at least one region of interest in at least one image frame of the segment,
adjust the two or more digital viewpoints so that the at least one region of interest remains in the displayed portion throughout the segment,
create a set of video clips, wherein each video clip is composed of a sequence of images formed by a single digital viewpoint throughout the segment,
assign a common timeline to each of the video clips in the set of video clips, and
record metadata in the memory, the metadata comprising the common timeline assigned to each of the video clips.

10. A system as claimed in claim 9, comprising a directional audio recording unit, wherein the computer program code and the at least one memory are configured, with the at least one processor, to cause the device to
record an audio stream along with the captured omnidirectional video, and
focus the directional audio recording unit on at least one region of interest.

11. A system as claimed in claim 10, wherein the directional audio recording unit comprises two or more directional microphones.

12. A system as claimed in claim 9, comprising a gaze detection unit configured to detect a gaze direction of a camera user, wherein the computer program code and the at least one memory are configured, with the at least one processor, to cause the device to record metadata in the memory, the metadata comprising a detected gaze direction of the camera user.

13. A method comprising:
identifying two or more regions of interest in a segment comprising a sequence of image frames of the omnidirectional video, the two or more regions of interest identified based at least in part on one or more active objects detected in the segment,
defining two or more digital viewpoints, wherein each digital viewpoint encloses at least one region of interest throughout the segment,
creating a set of video clips, wherein each video clip is composed of a sequence of images formed by a single digital viewpoint throughout the segment, and
assigning a common timeline to each of the video clips in the set of video clips.

14. A method as claimed in claim 13, wherein identifying two or more regions of interest comprises receiving user input comprising a selection of two or more regions of interest.

15. A method as claimed in claim 13, comprising storing the set of video clips with the assigned common timeline in the memory.

16. A method as claimed in claim 13, comprising combining two or more video clips from the set of video clips according to a predetermined pattern based on the assigned common timeline, and creating a new video from the combined video clips

17. A method as claimed in claim 16, comprising storing the created new video in a memory.

18. A method as claimed in claim 13, wherein each digital viewpoint encloses at least one region of interest throughout the segment by locking onto and tracking the at least one region of interest.

19. A method as claimed in claim 13, comprising receiving a user input comprising an instruction to combine two or more video clips from the set of video clips, and
combining two or more video clips from the set of video clips according to the user input, and creating a new video from the combined video clips.

20. A method according to claim 13, comprising:
adjusting parameters of the digital viewpoint based on parameters of the identified regions of interest.
